(19) United States
(12) Patent Application Publication
(10) Pub. No.: US 2025/0302220 A1
(43) Pub. Date: Oct. 2, 2025

(54) Temperature-Maintaining Food Server

(71) Applicant: Eric Kai Yang, Newark, CA (US)

(72) Inventor: Eric Kai Yang, Newark, CA (US)

(73) Assignee: Eric K. Yang, Newark, CA (US)

(21) Appl. No.: 18/617,865

(22) Filed: Mar. 27, 2024

(51) Int. Cl. A47G 23/06; A47J 36/24

(52) U.S. Cl. CPC A47G 23/0683; A47J 36/2483

(57) ABSTRACT

Embodiments of the present disclosure relate to the fields of temperature maintaining food servers by using rechargeable batteries as power source. The temperature maintaining food server has a long resistor heater covering most of the serving area and has a serving surface compatible with cutting and serving operation. The temperature maintaining food server is made to resist water for easy cleaning.

### TECHNICAL FIELD

The present disclosure relates to the fields of food serving containers with temperature maintaining capability.

### BACKGROUND

Serving food with its desirable temperature is a long-lasting need in human society. Food becomes less appetizing when it is allowed to cool. The easiest approach of designing a Temperature-Maintaining Food Server (TMFS) is to serve food on containers with very large thermal masses or with heat insulation, such as preheated stone, ceramic plates, and metals, or thermos and coolers as shown in FIG. 1. This approach is generally considered as “passive” approaches which do not rely on any external power source during the time of serving of food. The passive TMFS approaches are inexpensive and flexible in use. And, in many cases, they are portable, e.g., being placed on a dinner table. However, the temperature of the food server continues to change after it leaves a heater or a cooler. The longer it leaves the heater/cooler, the more the temperature changes. The rate of temperature change can be reduced by placing material with large thermal mass in a thermally isolated container. This is basically the operation principle of a cooler with a large quantity of ice inside.

There are approaches categorized as passive TMFS approaches which have integrated heaters, for example, an electrical lunch box with integrated heater which can be powered by AC or DC power input as shown in FIG. 2. However, when the TMFS is moved away from the power source, the temperature starts to change.

“Active approaches” for TMFS are most often seen in food containers having overhanging heat lamps or a stove underneath as shown in FIG. 3. This heat lamp can be powered by electrical sources. The stove can be powered by electrical sources, natural gasses (e. g. methane), solid fuels (e. g. waxes), or liquid fuels (e. g. oils). For the cases of electrical sources, it is possible to integrate electronics and thermal sensors such that desirable temperature can be maintained. However, the active electrical TMFS approaches require power sources nearby which are typically not available in dining settings. For the cases of burning fuels, it is difficult to control the temperature because of space, cost, etc. The active fuel-burning TMFS approaches are generally bulky in use and require efforts to set up and set down, and manual control of temperature.

Both known passive and active approaches are not ideal and there has been a strong desire to have temperature-maintaining food servers with great ease of use, portability, to be cosmetically pleasing, and to not require any external power sources. Additional features such as the convenience of reaching for food, cutting food, using food-safe and utensil-friendly material, ease of cleaning, and storage are also important for commercial or home usages.

### BRIEF SUMMARY

The present disclosure describes a battery-powered temperature-maintaining food server (BP-TMFS) which exhibits all above-mentioned desirable features. The BP-TMFS does not require an external power source when serving the food. To compensate for the heat loss during serving food, the BP-TMFS provides heat by internal battery-powered large-area resistor heaters. The BP-TMFS can be made of food-safe material and be dish-washable. The BP-TMFS can maintain the food temperature at a settable temperature. The BP-TMFS can maintain multiple surface temperatures to accommodate hot or cold drinks.

In one embodiment, a temperature-maintaining food server comprises a middle heating piece, a top serving piece, a battery assembly for rechargeable batteries, a control module, and a bottom support piece. The middle heating piece comprises a heating element, a temperature sensor and optional metal heat spreader. The top serving piece comprises a serving surface at a top side for serving food and a first cavity at an opposing side. The first cavity receives the middle heating piece. The bottom support piece comprises a second cavity and a third cavity at the top side. The second cavity receives the battery assembly and the third cavity receives the control module. The top serving and the bottom support piece are bonded together to prevent water leakage to the first, second and third cavities.

In another embodiment, a temperature-maintaining food server further comprises traces of metal resistor heaters on a flexible substrate. In another embodiment, the heating element comprises multiple heating zones, wherein each heating zone is electrically powered separately.

In another embodiment, the heat piece comprises a heat spreader configured to form multiple temperature zones.

In another embodiment, a temperature-maintaining food server further comprises an electronics module which is configured to charge said rechargeable batteries. In another embodiment, the electronics control module assembly is further configured to control a temperature of the serving surface to a pre-set temperature by providing power to the heating element according to a reading of the temperature sensor. In another embodiment, a temperature-maintaining food server further comprises a remote charging coil which is configured to charge said rechargeable batteries wirelessly.

In another embodiment, a temperature-maintaining food server comprises a serving surface made of wood.

In another embodiment, a temperature-maintaining food server comprises a serving surface made of ceramic.

In another embodiment, a temperature-maintaining food server comprises a serving surface made of glass.

In another embodiment, the top serving piece of a temperature-maintaining food server comprises one or more compartments such that some areas have temperature-maintaining function and some do not.

In another embodiment, the top serving piece of a temperature-maintaining food server comprises a rectangular top surface. In another embodiment, the top serving piece of a temperature-maintaining food server comprises a round or oval top surface.

These and other aspects of the present disclosure will be apparent from a reading of the following detailed description together with the accompanying figures, which are briefly described below. The present disclosure includes any combination of two, three, four or more features or elements set forth in this disclosure, regardless of whether such features or elements are expressly combined or otherwise recited in a specific example implementation described herein. This disclosure is intended to be read holistically such that any separable features or elements of the disclosure, in any of its aspects and examples, should be viewed as combinable unless the context of the disclosure clearly dictates otherwise.

It will therefore be appreciated that this Summary is provided merely for purposes of summarizing some examples so as to provide a basic understanding of some aspects of the disclosure without limiting or narrowing the scope or spirit of the disclosure in any way. Other examples, aspects, and advantages will become apparent from the following detailed description taken in conjunction with the accompanying figures which illustrate the principles of the described examples.

### BRIEF DESCRIPTION OF THE DRAWINGS

For a more complete understanding of various examples, reference is now made to the following detailed description taken in connection with the accompanying drawings in which like identifiers correspond to like elements:

FIG. 1 shows prior art examples of “Passive” approaches for TMFS.

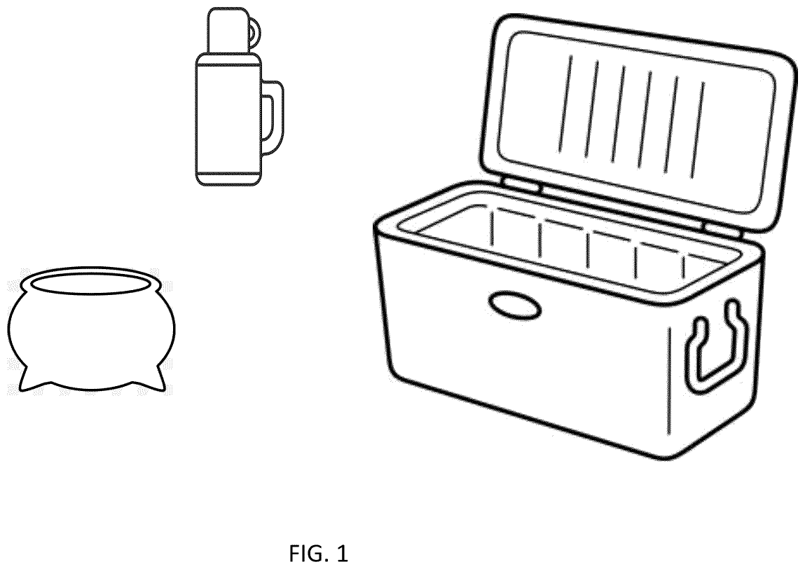

FIG. 2 shows an example of “Passive” approaches for TMFS having an integrated heater without an integrated energy source.

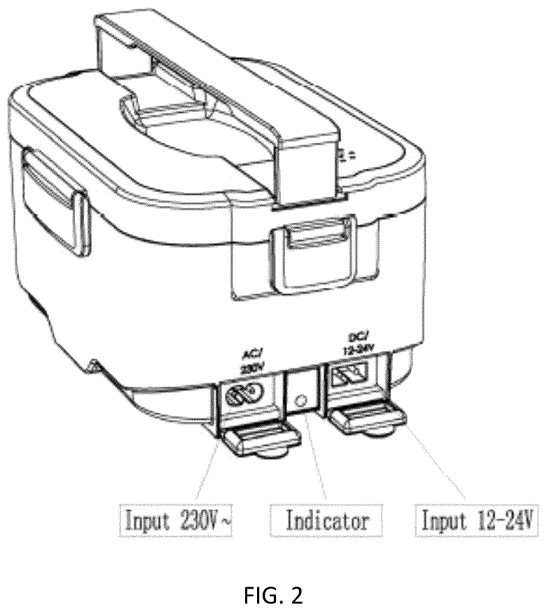

FIG. 3 shows prior art examples of “Active” approaches for TMFS.

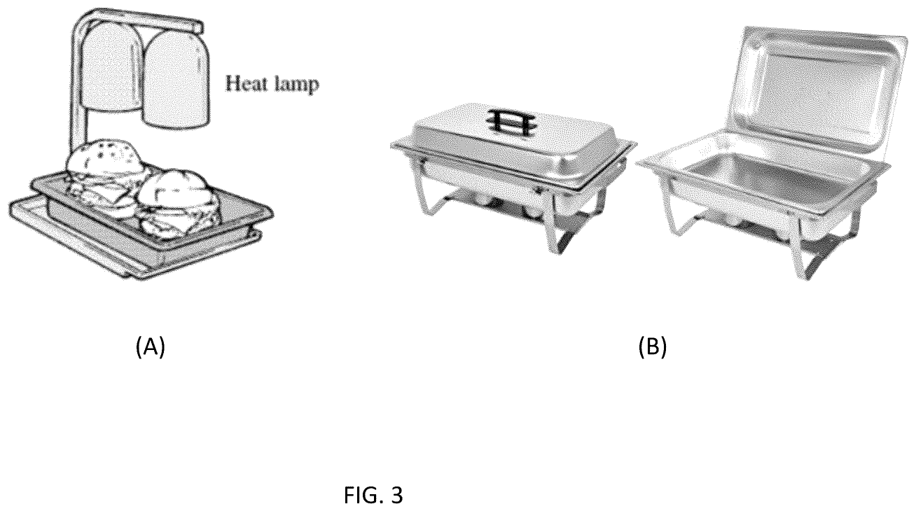

FIG. 4 illustrates processes of heat transfer with an example of a pot on a stove.

FIG. 5 depicts some heating coils commonly used in stoves, ovens, and portable kettles.

FIG. 6 depicts flexible resistor heating pads on silicone rubber glass fiber cloth.

FIG. 7 depicts a BP-TMFS according to some embodiments of the present disclosure.

FIG. 8 depicts a BP-TMFS according to some embodiments of the present disclosure.

FIG. 9 depicts additional features of a BP-TMFS according to some embodiments of the present disclosure.

FIG. 10 depicts additional features of a BP-TMFS according to some embodiments of the present disclosure.

FIG. 11 depicts an additional remote charging feature of a BP-TMFS according to some embodiments of the present disclosure.

FIG. 12 depicts the concept of selectivity of heating zones of a BP-TMFS, made possible with heat spreader 1220.

FIG. 13 depicts the various embodiments of a BP-TMFS.

FIG. 14 depicts round or oval embodiments of a BP-TMFS.

### DETAILED DESCRIPTION

Various embodiments and aspects of the disclosures will be described with reference to details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures. Without limiting the scope of the present invention, embodiments of the disclosure provide examples implemented.

Through the following analyses, the basic concept and the associated issues with a BP-TMFS will be discussed to show how the present invention actually functions. We first present the present invention from the physics perspective by feasibility analysis and compatibility analysis. Then, we discuss how such combinations could be applied to food servers with the consideration of use perspectives with usability analysis and maintenance and safety requirements. After passing all analyses, we present the construction of battery-powered TMFS with various embodiments.

Feasibility Analysis. The conventional active TMFS approaches use conventional heat sources known to human society as energy sources for cooking. Batteries have been used to provide portable energy to power small electronics devices such as laptop, radio, cellphone and small gadgets. How long the batteries can last has been constant struggles for the usages needing more power, as in extreme cases the electric vehicles. For battery-power devices, the energy-storage/size ratio largely determines their practicality. Using battery power for cooking falls into the impractical side because the power available from batteries with reasonable sizes is many orders of magnitude too small for cooking applications. As a reference, typical electrical kettles require at least 1500 W just to heat up a small amount of water. However, cooking is different from maintaining temperature which requires far less power. To illustrate the practicality of using batteries for TMFS, heat transfer analysis is exemplified below using a specific design without losing generality.

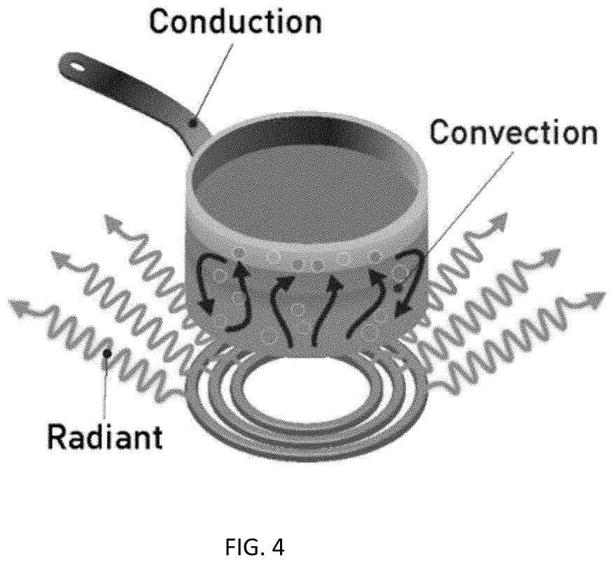

Heat transfer, through the processes of convection, conduction, and radiation as depicted by FIG. 4, is well understood. Conduction is a process of transmission of energy from one particle of the medium to another with the particles being in direct contact with each other. Convection is caused by the movement of fluid molecules from higher temperature regions to lower temperature regions. Thermal radiation is generated by the emission of electromagnetic waves called blackbody radiation. These waves carry away the energy from the emitting body. The higher temperature, the more radiation is generated. Thus, a net energy flow from a body with a higher temperature to a body with a lower temperature.

In the cases of TMFS, all three processes are involved to transfer the heat from the surface of TMFS to its surrounding environment. Generally, the convection process dominates the heat transfer because the foods need to be accessible, requiring a relatively large open space which allows for air movement. This is why a conventional wisdom to keep food in a container warm is to cover it with a lid. The accessibility also disqualifies the approaches using insulating boundaries employed by ice chests and thermos.

The typical temperatures of the desired foods (Tₛ) are in the range of 50° C. to 80° C. The room temperatures (Tᵣₘ) are typically between 20° C. to 30° C. At these temperatures, the black body radiation is very small and thus can be ignored in our analysis. If the TMFS is provided on dinner tables, the conduction is also relatively small. For simplicity, we assume the heat conduction path to the tables is made small by designs (e. g. insulating materials at the bottom).

The free air convection coefficient (h) is between 2.5 to 25 W m⁻² K⁻¹, depending on the geometries and configurations. We can estimate the heat loss (H) by EQ. 1 below, where Aₒ is the surface area of TWFS.

$$H = h {A}_{o} ( {T}_{s} - {T}_{rm} ) \qquad EQ . 1$$

For a typical TMFS, the dimensions of the surface are 0.3 meter by 0.2 meter (Aₒ=0.06 m²). The temperature difference between the food and the room is about 50° C. According to EQ. 1, the heat loss is less than 75 W. The design guideline for a 0.06 m²-TMFS is to provide a continuous 75 W of heat to maintain the food temperature, which is far less than 1500 W commonly found in electric kettles. For example, a typical AA-size Li-ion battery stores 3A-hour at 3.7V (or equivalent ˜11.1 Watt-hour). Therefore, it is possible to use 6 AA-size Li-ion batteries (˜66.6 Watt-hour) to supply the TMSF for nearly one hour. The area occupied by 6 AA-size Li-ion batteries is 0.06 meter by 0.011 meter (or 0.0066 m²) which is much smaller than the surface area of the TMFS (0.06 m²). The area ratio of battery over TMFS is 11% (for single layer arrangement) for a one-hour operation in the worst scenario. Therefore, to extend the operation duration, one can simply use more batteries. For example, 12 AA-size Li-ion batteries (˜133.2 Watt-hour) to supply the TMSF for nearly two hours in worse scenarios. Still the batteries only require 22% of areas of TMSF at most. The technology for rechargeable batteries continues to improve with higher storage capacity and lower cost, making battery-powered TMSF more favorable.

The above analysis is simply to show the feasibility of a battery-powered TMFS which is not generally realized, resulting in no commercial TMFS products using rechargeable batteries as internal power sources. With the advance of Li-ion batteries for energy storage and the volume production with lower price in recent years, battery-power TMFS is not only feasible but also economically preferable over other means. This is because other costs associated with active TMFS approaches require additional constructions for safety and mechanical support structures, as explained below.

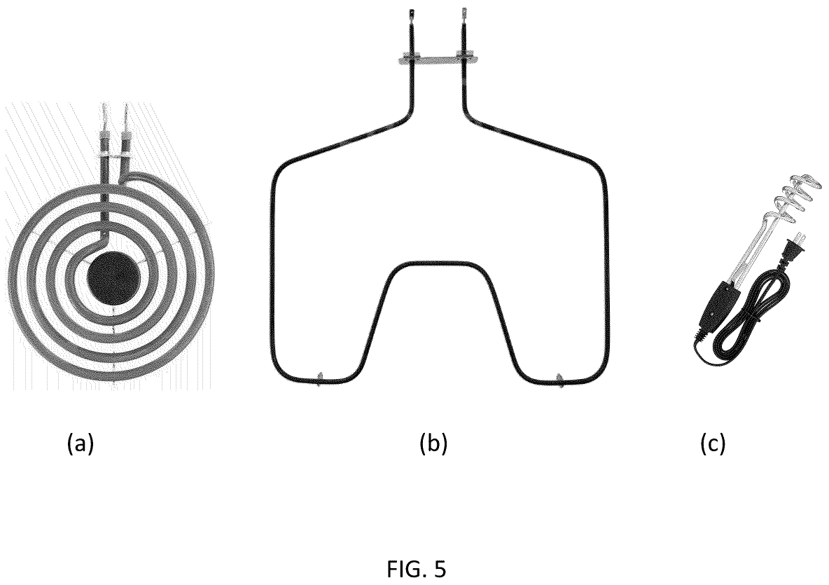

Compatibility Analysis. While rechargeable batteries are proven a viable energy source in the above analysis, it still requires additional invention steps to use it as heat sources. The easiest way to convert the stored energy in batteries into heat is to use electrical heaters. Yet, typical heaters are designed for much higher wattages for practical uses. Most of the heaters employ radiation heat transfer which require the heating coils (seen in conventional ovens and stoves as shown FIGS. 5a and 4b) to be as hot as >500° C. For the case of the heater in a portable kettle, the heat coil has to be enclosed by a metal casing to conduct the heat from the coil to the water more uniformly. Although the heating coil comprises resistors, the method of heating transfer from the heater to the metal casing is mostly by radiation or convection. The required temperatures for the heating coils are much higher than the food in order to have efficient heat transfer by radiation or convection. Using heating coils or burning fuels, there needs to be a good distance to distribute the heat from the heat source evenly to the food. Otherwise, the temperature of the foods could not be kept in a small desired range.

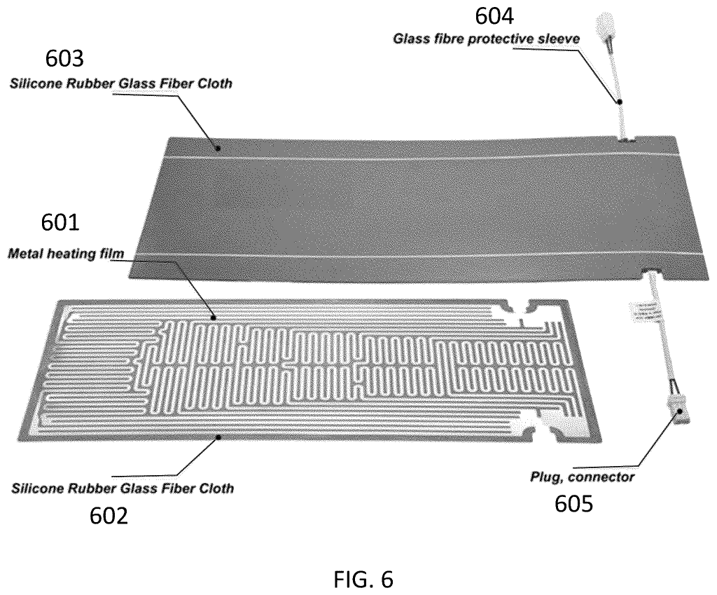

For the applications for TMFS, a desired heating element is a long resistor uniformly covering a large area, as exemplified in FIG. 6. Instead of hot short coils, the heating element is made of a very long resistor 601 which is a metal heating film purposely etched into traces with small spacings in between. The metal resistor 601 is embedded between two sheets of silicone rubber cloth (602 and 603) to insulate the wiring from the environment and between traces. There are multiple metal heating traces, carefully designed to provide uniform heat across the entire area. The spacings between the metal traces are small enough so that it produces uniform heating after the heat is transferred through the silicone rubber cloth. In addition, some of heating pads are designed to use low voltage (such as 12V), instead of 120V or 240V AC from wall outlets. This low voltage design allows the use of batteries without involving complicated voltage up-converter circuitry. The values of resistance of the metal heating film 601 can be precisely fabricated by a masking-etching process similar to a standard PCB (printed circuit board) process.

The use of low voltage of the heating pads makes them compatible with battery power sources. We can create a power source of 11.1V by configuring three 3.7V rechargeable batteries in series.

Usability Analysis. A food server should have a surface which is easy to clean and safe for food contact. The surface should be strong enough to operate with metal utensils or even sharp knives. In addition, the surface should be cosmetically pleasing. Further, the surface should be reasonably thermal conductive to transfer the heat to the food. Out of many options, a wood surface is most favorable, followed by a glass surface. It is always possible to use wood with a thin glass cover to achieve combined effects. Alternatively, containers made of thin glass can be placed on a TMFS having a wood surface. Because glass generally has poor thermal conductivity, it is preferable to use thin glass near the surface for its durability but support the thin glass with wood or metal plates.

In one application of TMFS, it is used to serve large portions of meats (such as steak or ham) or pizza which are preferable to be cut just before serving. A wood surface is most acceptable to users because wood is commonly used as chopping boards. Glass is not suitable for chopping because it will quickly dull knife blades. However, a glass surface is good for serving soups and dishes.

In another application of TMFS, it can be used as a carrying plate with multiple compartments for a cafeteria environment. The users can pick up food from the vendors and carry the TMFS to dining areas. Optionally, the TMFS can include selected areas with no temperature maintaining function for cold drinks.

In another application of TMFS, it can be made into food containers for keeping food warm on the dining table, for example, bread or rice. Again, wood surface is best for this because of cutting or utensil usage.

In all above applications, the serving surface for its mechanical properties and cosmetic characteristics needs to be compatible with heat transfer. The heat transfer process from the serving surface to the food is dominated by heat conduction. Glass, unless very thin, is not a good heat conductor. On the other hand, metals, which are good heat conductors, have cosmetic drawbacks. Metal surfaces are prone to visible scratches, oxidation marks and dull appearances. In some cases, metal surfaces are too thermally conductive so that they should not be touched by bare hands when it is hot. Wood has thermal conductivities between glass and metals. When it is touched by hands accidentally, it does not cause burns. It conducts heat just effectively enough to keep the food warm. In fact, wood would not be ideal as a food cooker because it could deform at very high temperatures. Between 50° C. to 80° C., the wood surface is ideal to be used to serve food for the reasons explained above.

Maintenance and safety requirements. A battery-powered TMFS is preferably dishwasher safe, and at the very least, hand wash safe. This means all electronics parts should be water-sealed or conveniently removable. In addition, because of potential fire hazard along with rechargeable batteries, they should be air-tight so that they would not be exposed to oxygen. Water sealing is very easy to achieve in a wood construction. Humans have made boats and wine barrels out of wood for thousands of years. This is because wood can be sealed easily with glue and grease. Metals and glass are not as easy because they can delaminate from glue lines because they do not bond with glues chemically.

From the above discussion, it is now clear that battery-powered TMFS possesses unique features not found in any prior art or combinations of prior art.

Construction of battery-powered TMFS. As explained above, it is preferable to use wood as the serving surface and also forming water-seal. While other materials are possible to be used, the description of the construction of battery-powered TMFS below uses wood for the illustration purpose. The people having ordinary skills in the art would understand that other materials can be used, for example, molded glass, metals, molded plastics, ceramics or combinations of these materials.

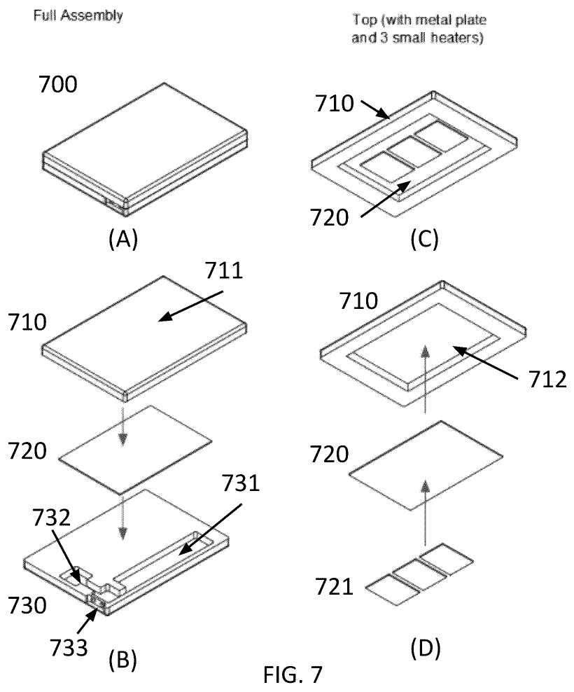

FIG. 7A depicts the construction of a battery-powered TMFS 700 which comprises three main subassembly layers. FIG. 7B shows an upper view of the top piece 710 having a top external surface 711 which is the serving face for the food. FIG. 7C shows a lower view of the top piece 710 having a middle metal piece 720 in it. FIG. D shows a lower view of the top piece 710 having a cavity 712. The cavity 712 receives middle piece 720, a metal heat spreader with attached heating pads 721. FIG. 7D shows 3 heating pads 721 for illustration purposes. Any number of heating pads can be used as long as uniform heating is accomplished by the design. As shown in FIG. 7D, the metal heat spreader does not extend all the way to the edge of the top piece 710. Therefore, the edge of the top plate of 710 is not effectively heated and will have a cooler temperature for easy handling by hands. The purpose of the metal heat spreader in 720 is to allow lateral heat distribution so that the temperature of the serving surface 711 is more uniform. Further, one or more temperature probes (not shown) are mounted to the metal heat spreader 720 to measure the plate temperature. Alternatively, the heaters are designed to achieve the desired temperature profile so that the heat spreader is not necessary. After the middle piece 720 is placed into the cavity 712 as shown in FIG. 7C, the bottom piece 730 is attached to the top piece 710 with glue along the edge of the top piece 710 to cause water seal. Optionally, an insulating material sheet is placed between the middle piece 720 and the bottom piece 730 to reduce the heat conduction downward. In addition, the thickness of the top piece 710 is designed so that the thermal resistance is not too high. The thickness of the top piece 710 is between 2 mm to 20 mm, preferably 5 mm for high mechanical strength and low thermal resistance. To reinforce mechanical strength, mechanical supports can be made between the top piece 710 and the bottom piece 730 directly under the middle piece 720. The overall thickness of battery-powered TMFS 700 is preferably less than two inches (or 50.8 mm), but there is no limit besides usability considerations. The top surface of battery-powered TMFS 700 can be rectangular, round, oval or any proper shapes for its intended purpose. The largest horizontal dimension of battery-powered TMFS 700 is preferably less than 20 inches. As discussed above, a larger surface area will lose more heat through the convection process, thus needing to provide higher power to the heating resistors, requiring more rechargeable batteries.

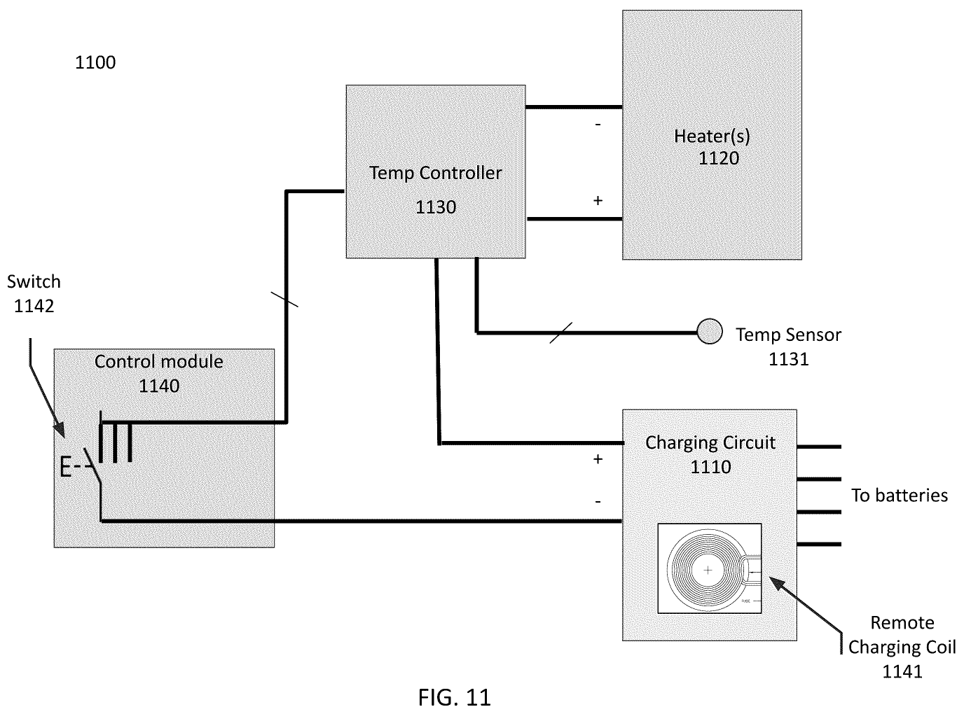

As depicted in FIG. 7B, several cavities are made into the bottom piece 730. The cavity 731 is the battery compartment. The details of the battery assembly will be discussed below. The size of the cavity 731 is determined by the overall size of the battery assembly. The cavity 732 is the electronics compartment. The electronics assembly will be discussed in detail later. The electronics assembly is electrically connected to the battery assembly, temperature probes and the heating pads. In one embodiment, the cavity 733 receives a control module assembly having at least a sealed connector for charging and a sealed on-off switch to control the electronics module assembly. Rubber gasket, O-ring or epoxy can be used to ensure sealing between the control module assembly and the cavity 733. In another embodiment shown in FIG. 11, the control module assembly employs a remote charging coil 1140. The remote charging is performed by wireless charging. The remote charge approach is advantageous because it does not require a physical receptacle, thus easing water sealing requirements.

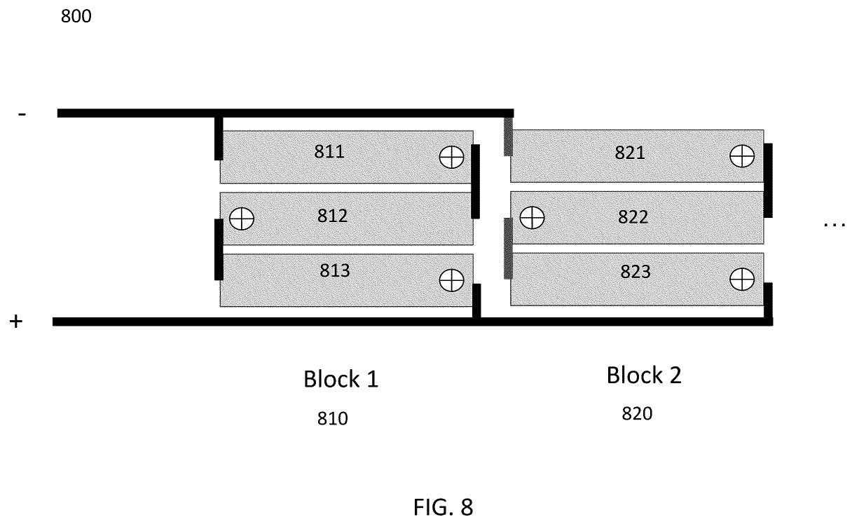

As discussed in the feasibility analysis, the number of batteries is determined by the duration requirement of the operation. In that example, 6 AA-size rechargeable batteries are used. In the same example, an operation voltage of ˜11.1V (close to 12V) by stacking 3 batteries is suggested. FIG. 8 depicts a battery arrangement of 2P3S where 2P stands for 2 parallel paths and 3S stands for 3 batteries in series. In Block 1 (810), batteries 801, 802, and 803 are electrically connected in series because the positive electrode (anode) of battery 801 (and battery 802) is connected to the negative electrode (cathode) of battery 802 (and battery 803). Block 1 (810) and Block 2 (820) are electrically connected in parallel because the negative (and positive) side of Block 1 is connected to the negative (and positive) side of Block 2 (820). The number of batteries in series in a block determines the operation voltage. The number of blocks determines the overall electrical energy storage. Although specific voltages are used to illustrate the battery arrangement, a person of ordinary skill in the art (POSITA) will understand there are various voltages arrangements that can be used to achieve similar results.

The battery arrangement in FIG. 8 requires a single pair of charging wires with a voltage typically 12.6V. However, such an arrangement is vulnerable to battery degradation. Because the same current flows through a block, all batteries in the same block receive the same amount of charge. If one battery degrades and can only be charged a fraction of its original capacity, all batteries in the same block receive the same amount of recharging and can be only charged the same fractional amount as the degraded battery.

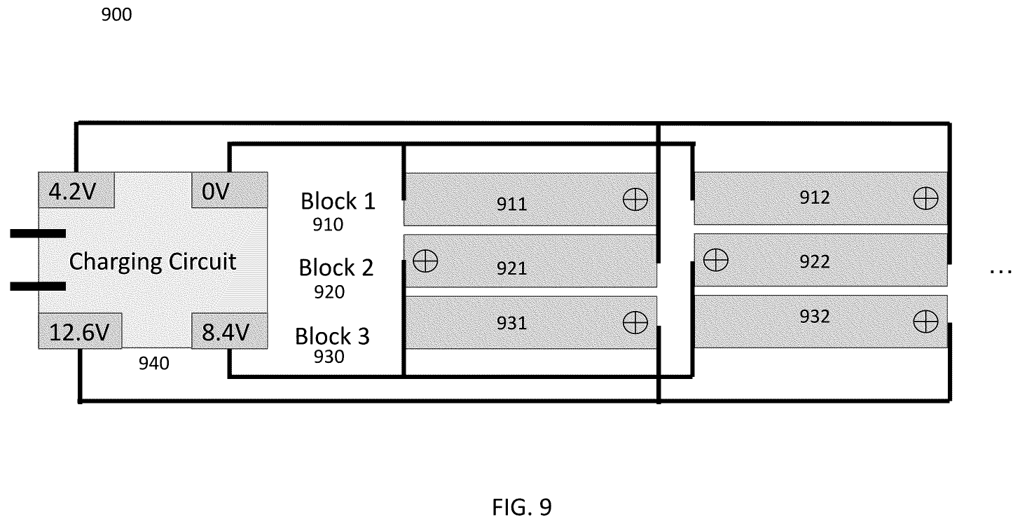

To overcome the shortfall caused by single battery degradation, a different battery arrangement 900 can be used as shown in FIG. 9. In FIG. 9, 6 batteries are arranged into 3 blocks. Each block (e. g. 910) consists of two connected batteries connected in parallel (e. g. 911 and 912). Blocks 910, 920 and 930 are electrically connected in series. In addition, each block is directly connected to the charging circuit 940. The charging circuit 940 charges each battery block separately. If one battery is degraded and has a less capacity, it will not affect other batteries in other blocks. When the external charging power is disconnected, the charging circuit 940 will cause the 4.2V and 8.4V electrodes to be floating. The battery stack 900 will function as a 11.1V voltage source, just like the battery arrangement 800 in FIG. 8.

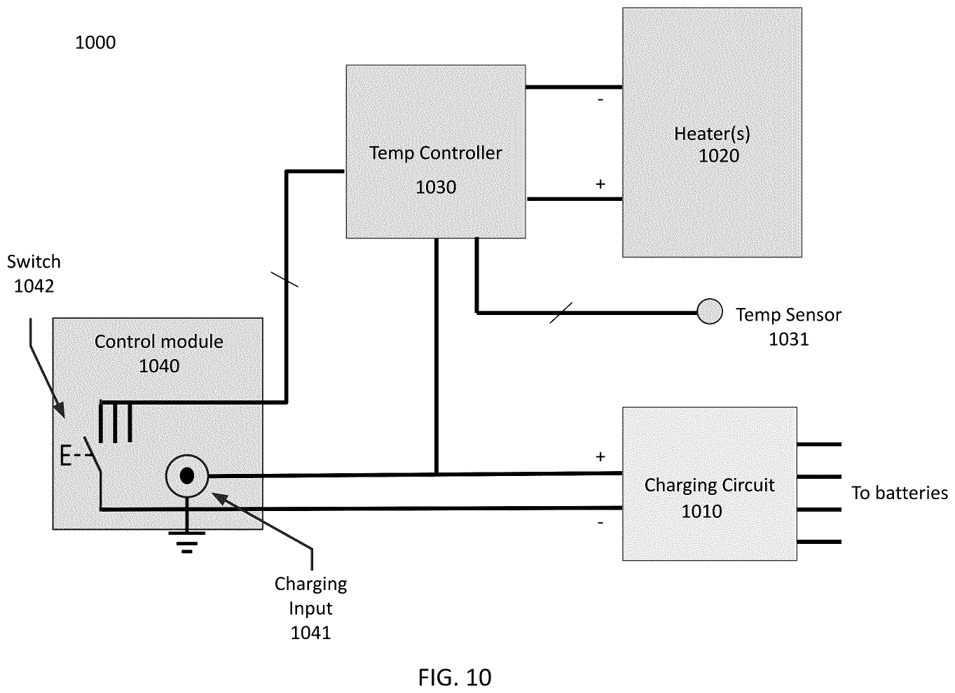

The control circuit diagram 1000 of BP-TMFS is illustrated in FIG. 10 comprising charging circuit 1010, heaters 1020, temperature controller 1030 and control module 1040. The charging circuit 1010 and heaters 1020 are explained previously. The temperature controller 1030 along with its temperature sensor 1031 regulates the current flow into heaters 1020 according to the temperature setting. The setting can be set in the factory or can be controlled by a position switch 1042 in Control module 1040. In Control module 1040, the charging input 1041 is to be connected to external power. The input voltage is a DC voltage which can be directly fed to the charging circuit. Although specific voltages are used to illustrate the battery arrangement, a POSITA will understand there are various circuit arrangements that can be used to achieve similar results.

As described previously and shown in FIG. 11, the charging can be performed wirelessly without a direct DC input 1041. The remote charging coil 1141 can be used to receive external power to charging circuit 1110 which charges the batteries.

According to the control circuit diagram 1000 for the BP-TMFS, the temperature of the TMFS is maintained by turning the heater(s) on and off by the temperature controller 1030. The temperature sensor 1031 returns a signal representing the temperature of an area where the sensor is located. In one embodiment, only one temperature sensor is used. The temperature controller turns on the heater when the return signal from the temperature sensor 1031 is below a pre-selected value. In another embodiment, multiple temperature sensors and multiple heaters are used. The temperature controller determines the heater currents according to the return signals from the temperature sensor 1031. Alternatively, temperature controller 1030 and the temperature sensor 1031 are integrated into one component such as a fixed-temperature control switch. Multiple fixed-temperature control switches can be used along with multiple-position switches to allow multiple predetermined temperatures.

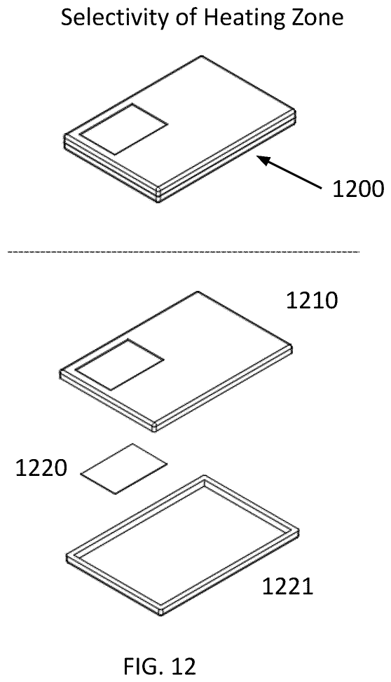

As mentioned above, the BP-TMFS may optionally only maintain the temperature in certain areas. This feature is uniquely different from all other TMFS's which are intended to keep the entire compartment at the same temperature. The present invention is constructed unique such that the heat spreading laterally is enhanced by a heat spreader 720 in FIG. 7. Therefore, the selectivity of the heated area is largely determined by the size and the location of the heat spreader as illustrated in FIG. 12. In FIG. 12, the heat spreader 1220 is shown to cover a small area of the entire BP-TMFS, 1200. Alternatively, it can cover most of the area of the BP-TMFS and only leave a small area uncovered. This selectivity enabled by the heat spreader allows the BP-TMFS to serve various purposes. As an example of the small area heated area, it can be used a plate to serve hot drink or soup with higher maintaining temperatures while using small battery capacity (also lower weight). As an example of the large area heated area, it can be used a plate to serve food while carrying cold drinks. It is clear to a POSITA, it is possible to have a BP-TMFS to have multiple temperature zones by designing the heat spread with different shapes. For example, the heat spread might have an area having a comb shape to reduce the heat transfer in that area and having a lower temperature. Similar effects can be achieved with multiple heaters. This selectivity is made possible by the employment of a heat spreader which is not present in the prior art TMFS's.

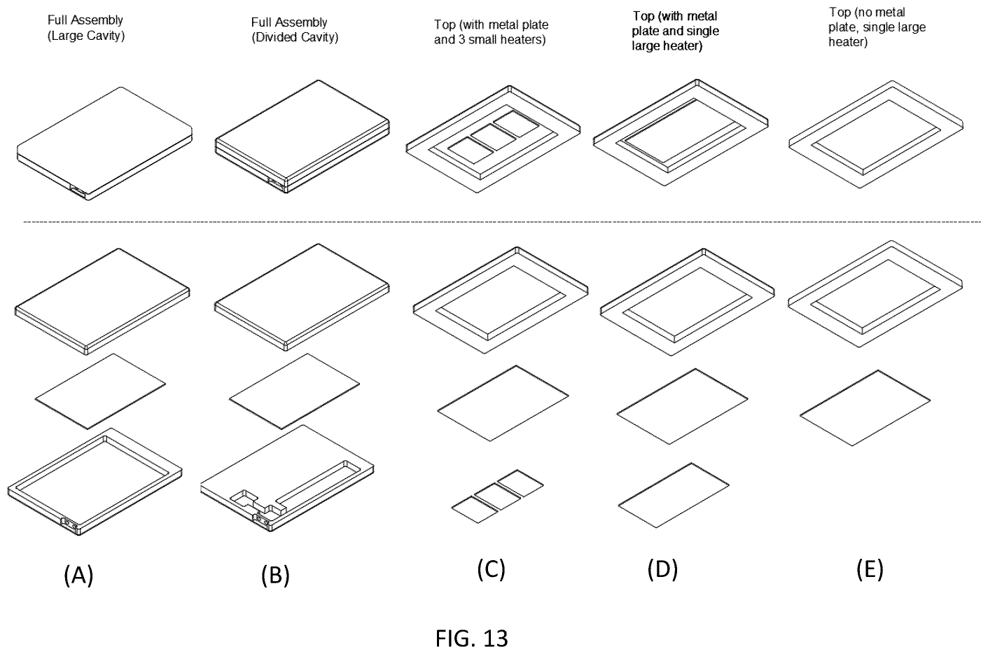

Many specific embodiments were used discussing the construction of the BP-TMFS using FIG. 7. However, there are a large variety of embodiments for how the present invention can be realized. FIG. 13 is intended to show some varieties. FIG. 13B is identical to FIG. 7B which is included for comparison purposes. As compared with FIG. 13B, FIG. 13A uses a simple cavity in the bottom piece. In this embodiment, the separation between different compartments can be accomplished via special packaging. For example, the battery pack can be placed inside a sealed bag to avoid fire hazard or allow replacement of the battery pack. The electronics can be sealed by epoxy coating.

FIG. 13C has an identical heating arrangement as FIG. C where it consists of a metal heat spreader and three small heaters. A POSITA would understand 3 heating pads are used only for example. One can use one or two or many heating pads to achieve the design objectives. The combination of heater numbers, heater locations and the design of the heat spreaders can achieve a large variety of temperature profiles. FIG. 13D illustrates an embodiment consisting of a metal heat spreader with a single large heater. As explained previously, the metal heat spreader does not need to be uniformly constructed. By using some cut holes (in comb shapes or honeycomb shape), the lateral heat transfer can be altered to achieve multiple temperature zones. FIG. 13E shows an embodiment consisting of no metal heat spreader and utilizing heating pad(s) to directly apply the heat to the surface.

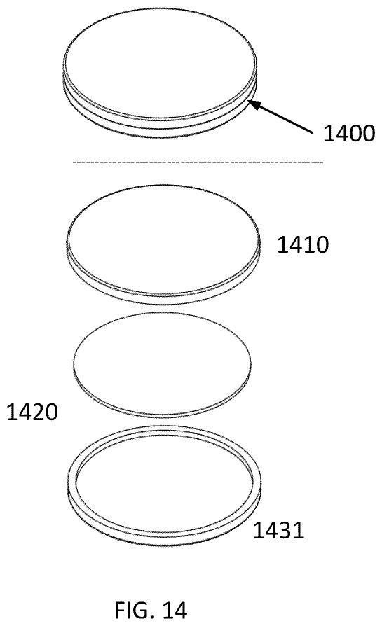

The BP-TMFS's shown in FIGS. 7, 12 and 13 have rectangular shapes only for illustration purposes. The present invention is not limited to rectangular shapes. As shown in FIG. 14, a round shape or an oval shape BP-TMFS's are illustrated. The flexibility of shape is enabled by the employment of heat spreaders and/or the heating pads. A round shaped BP-TMFS with a wood surface is ideal to serve pizza. The wood surface enables the cutting of pizza with ease, unlike most of the cardboard containers.

Although the discussions above focus on the temperature maintenance and carrying aspects, the BP-TMFS can be used as a personal dinner plate for one person to use during a group meal. All the food brought to a personal BP-TMFS will be kept warm before eating, prolonging the enjoyment of food with conversation. In comparison with cast iron sizzling steak plates (a form of passive TMFS), a personal BP-TMFS steak plate provides a long serving time without overcooking the steaks.

Although the discussions above focus on the temperature maintaining and carrying aspects, the top surface of the BP-TMFS is not limited to be flat as drawn in FIGS. 7, 12, 13, and 14 for the purpose of clarity. The BP-TMFS's top surface can take the shape of a bowl or a tank so that the top surface is substantially not flat so that it can retain liquid from spilling out.

As explained above, BP-TMFS can be used in many ways and for many different purposes not achievable from the prior art TMFS, either passive or active. The BP-TMFS brings unique dining experiences which do not exist in those TMFS's which simply combine a heater and a container/plate.

The preceding description sets forth numerous specific details such as examples of specific systems, components, methods, and so forth, in order to provide a thorough understanding of several examples in the present disclosure. It will be apparent to one skilled in the art, however, that at least some examples of the present disclosure may be practiced without these specific details. In other instances, well-known components or methods are not described in detail or are presented in simple block diagram form in order to avoid unnecessarily obscuring the present disclosure. Thus, the specific details set forth are merely exemplary. Particular examples may vary from these exemplary details and still be contemplated to be within the scope of the present disclosure.

Although the operations of the methods herein are shown and described in a particular order, the order of the operations of each method may be altered so that certain operations may be performed in an inverse order or so that certain operations may be performed, at least in part, concurrently with other operations. Instructions or sub-operations of distinct operations may be performed in an intermittent or alternating manner.

The above description of illustrated implementations of the invention, including what is described in the Abstract, is not intended to be exhaustive or to limit the invention to the precise forms disclosed. While specific implementations of, and examples for, the invention are described herein for illustrative purposes, various equivalent modifications are possible within the scope of the invention, as those skilled in the relevant art will recognize. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Furthermore, the terms “first,” “second,” “third,” “fourth,” etc. as used herein are meant as labels to distinguish among different elements and may not necessarily have an ordinal meaning according to their numerical designation.

What is claimed is:

1. A temperature-maintaining food server comprising:
a middle heating piece, comprising one or more heating elements;
a temperature sensor;
a top serving piece, comprising a serving surface at a top side for serving food and a first cavity at an opposing side; wherein said first cavity receives said middle heating piece;
a battery assembly, comprising rechargeable batteries;
a control module, comprising an electronics control unit; and
a bottom support piece, comprising a second cavity and a third cavity at an upper side; wherein said second cavity receives said battery assembly and said third cavity receives said control module;
wherein said top serving piece and said bottom support piece are bonded together to prevent water leakage to said first, second and third cavities.

2. The temperature-maintaining food server in claim 1, wherein said one of more heating elements further comprises traces of metal resistor heaters on flexible substrates.

3. The temperature-maintaining food server in claim 1, wherein said one or more heating elements comprises multiple heating zones, wherein each heating zone is separated electrically powered.

4. The temperature-maintaining food server in claim 1, wherein said middle heating piece further comprises a metal heat spreader.

5. The temperature-maintaining food server in claim 1, wherein said electronics control unit is further configured to charge said rechargeable batteries.

6. The temperature-maintaining food server in claim 5, wherein said electronics control unit further comprises a remote charging circuitry to receive external power wirelessly.

7. The temperature-maintaining food server in claim 5, wherein said electronics control module assembly is further configured to control a temperature of said serving surface to a pre-set temperature by providing power to said heating element according to a reading of said temperature sensor.

8. The temperature-maintaining food server in claim 1, wherein said serving surface of said top serving piece is wood.

9. The temperature-maintain food server in claim 1, wherein said serving surface of said top serving piece is glass.

10. The temperature-maintaining food server in claim 1, wherein said serving surface of said top serving piece comprises one or more compartments.

11. The temperature-maintain food server in claim 1, wherein said top serving piece has lateral dimensions between 4 inches and 20 inches, and said temperature-maintaining food server has a vertical thickness less than 2 inches.

12. A temperature-maintaining food server comprising:
a middle heating piece, comprising one or more heating elements;
a temperature sensor;
a top serving piece, comprising a serving surface at a top side for serving food and a first cavity at an opposing side; wherein said first cavity receives said middle heating piece;
a battery assembly, comprising rechargeable batteries;
a control module, comprising an electronics control unit; and
a bottom support piece, comprising a second cavity at an upper side; wherein said second cavity receives said battery assembly and said control module;
wherein said top serving piece and said bottom support piece are bonded together to prevent water leakage to said first and second cavities.

13. The temperature-maintaining food server in claim 12, wherein said one or more heating elements further comprise traces of metal resistor heaters on flexible substrates.

14. The temperature-maintaining food server in claim 12, wherein said one or more heating elements comprises multiple heating zones, wherein each heating zone is separated electrically powered.

15. The temperature-maintaining food server in claim 12, wherein said middle heating piece further comprises a metal heat spreader.

16. The temperature-maintaining food server in claim 12, wherein the electronics control unit is further configured to charge said rechargeable batteries and to control a temperature of said serving surface to a pre-set temperature by providing power to said heating element according to a reading of said temperature sensor.

17. A temperature-maintaining food server comprising:
a middle heating piece, comprising a metal heat spreader, one or more heating elements, configured to form multiple temperature zones;
a temperature sensor;
a top serving piece, comprising a wood serving surface at a top side for serving food and a first cavity at an opposing side; wherein said first cavity receives said middle heating piece;
a battery assembly, comprising rechargeable batteries;
a control module, comprising a power receptacle, configured to charge said rechargeable batteries and to control a temperature of said serving surface to a pre-set temperature by providing power to said heating element according to a reading of said temperature sensor; and
a bottom support piece, comprising a second cavity at an upper side; wherein said second cavity receives said battery assembly and said control module;
wherein said top serving piece and said bottom support piece are bonded together to prevent water leakage to said first and second cavities.

18. The temperature-maintaining food server in claim 17, wherein said top serving piece has lateral dimensions between 4 inches and 20 inches and said temperature-maintaining food server has a vertical thickness less than 2 inches.

19. The temperature-maintaining food server in claim 17, wherein said top serving piece has an oval top surface with dimensions between 4 inches and 20 inches and said temperature-maintaining food server has a vertical thickness less than 2 inches.

20. The temperature-maintaining food server in claim 17, wherein said serving surface of said top serving piece further comprises a non-flat profile for the purpose of retaining liquid.
